(19) United States
(12) Patent Application Publication
(10) Pub. No.: US 2009/0024248 A1
(43) Pub. Date: Jan. 22, 2009

(54) Systems and Methods of Distributing Medications

(76) Inventor: Robert P. Hodson, Hartford, WI (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/780,809

(22) Filed: Jul. 20, 2007

(51) Int. Cl. G06F 19/00

(52) U.S. Cl. 700/242

(57) ABSTRACT

A system for securely providing medications in a group setting includes a medication dispensing apparatus for securely loading a portable medication container. The container can respond to one or more individual identifying indicia and unlock one or more storage containers which contain medications to be dispensed to the individual.

### FIELD OF THE INVENTION

The invention pertains to systems and methods for securely providing medications, for example prescription medications, in accordance with an individual's specific schedule. More particularly, the invention pertains to systems and methods which combine a medication dispensing apparatus for loading a portable medication container. The container can respond to one or more individual identifying indicia.

### BACKGROUND

As the population of individuals living in assisted care facilities as well as nursing homes increases, there is a continually expanding need to safely and securely provide prescription medications to such individuals in accordance with their specific personal schedule as prescribed by their physicians. It's important in such environments to avoid mix ups and/or confusion between individuals and medications, as well as medication schedules at the time of delivery of the medication.

Most jurisdictions require that the person dispensing prescription medications be a licensed professional. Examples include physicians, dentists, as well as registered nurses. With an expanding population of individuals living in assisted care facilities, nursing homes and other types of managed care facilities there is a continual need for qualified personnel to provide such dispensing services.

It's been recognized that there is value in being able to automatically associate an individual with a group of medications in accordance with a preset schedule. One solution in this regard was disclosed in U.S. patent application Ser. No. 11/180,490 filed Jul. 13, 2005 and entitled Biometric Medication Container. The '490 application is assigned to the assignee hereof and incorporated by reference.

Notwithstanding the effectiveness of the medication containers of the type disclosed of the '490 application, there continues to be a need for systems and methods which address medication schedules as well as secure distribution of the appropriate medication in a multi-individual of living environment. Preferably such systems and methods would be flexible enough to address substantially different medication schedules between different individuals as well as enabling professionals to add or delete medications and/or change respective schedules for such individuals.

### BRIEF DESCRIPTION OF THE DRAWINGS

FIG. 1 is an overall view of a system in accordance with the invention;

FIGS. 2A and 2B taken together illustrate various aspects of a portable medication dispensing;

FIG. 3 illustrates aspects of a method in accordance with the invention; and

FIGS. 4A, B taken together illustrate aspects of a dispensing method in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

A locking medication tray which embodies the invention could be implemented as a clear plastic tray with multiple compartments, of the appropriate size to fit a single does of medication. It could be filled by a automated dispenser which would assign a tray compartment to a specific patient.

Each compartment could be filled with the appropriate medication and locked. The assigned compartment could be unlocked only when in the vicinity of the patient.

A computer controlled identification mechanism would assure the patient only received the medication from their assigned compartment, because only that one would unlock. By eliminating the interaction between the non-licensed employee and the medication, it may become legal for a non-licensed employee to dispense the medication.

In one aspect of the invention, the medication tray would incorporate multiple locking compartments. The locks on the compartments would be normally engaged and seal each respective compartment.

The tray could contain a microprocessor which could be programmed with dispensing information when the medication is loaded into a tray compartment. The compartment would be assigned to an identifier of the patient who is to receive the medication.

Each compartment could be loaded with a single patient's dosage by an automated dispenser. The care giver would transport the filled tray to each patient in their route.

The tray would identify the patient by a bar code or RFID directly attached to the patient (wristband, badge etc). This id would be checked by the trays microprocessor and it would open the appropriate compartment for just that patient. It could also log the dispensing time.

When the tray is empty it would be returned to the automatic dispensing unit which would upload the medication dispenser logs and prepare it for the next schedule dose.

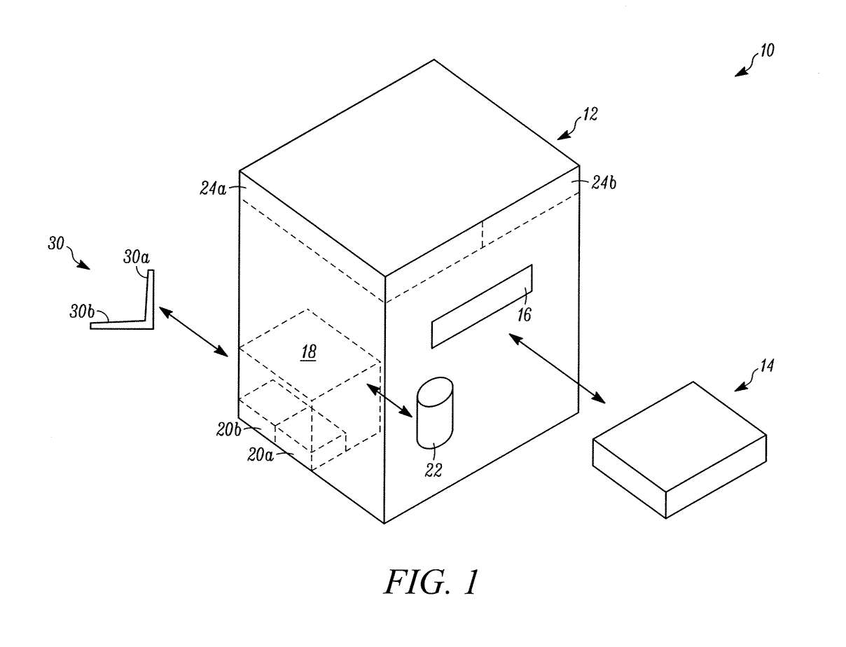

FIG. 1 illustrates a system 10 which embodies the present invention. The system 10 includes an automatic dispensing unit 12. Unit 12 obtains information in connection with dispensed medications from and provides a plurality of medications and scheduling information to a relatively portable medication dispensing container 14.

Container 14, as discussed in more detail subsequently, incorporates a plurality of compartments which can be filled with various medications, automatically, by the unit 12. To facilitate this process, container 14 can be inserted into a slot or opening 16 in unit 12.

When the container 14 has been inserted in the slot 16 of the unit 12 it can communicate, electrically, with an internal control unit, indicated in phantom, 18. The control unit or control circuits 18 can incorporate a programmable processor 20a and associated executable software 20b as well interface circuitry of a type that would be known to those of skill in the art for communicating with container 14. Additionally, control circuits 18 can incorporate a mass storage unit, either a magnetic or optical drive 22 which can support a database of patient medication schedules as well as dispensing information.

The unit 22 and associated database are accessible to the control circuits 18 and programmable processor 20a. The unit 12 also incorporates a medication storage area 24a and associated dispensing mechanisms 24b indicated in phantom.

The dispensing mechanism 24b is coupled to and operates under the control of the control circuits 18 to dispense medications in accordance with an individual schedule, loaded onto the database stored on unit 22. Medication storage area 24a and dispensing mechanisms 24b are enclosed in a secure region of unit 12.

A user's terminal 30, which could be implemented with a personal computer, could be in wired or wireless communication with the processor 20a and the control circuits 18. The terminal 30 can support a graphical user's interface on a display unit 30a by which an operator or user can either add or modify stored dispensing schedules, stored in unit 22 or obtain information as to medications dispensed by container 14. A keyboard, mouse, or other user input device 30b can also be provided to enable the user to input or modify the medication schedule or schedules stored on unit 22.

In one aspect of the method in accordance with the invention, the dispensing container 14 can be inserted into slot 16 and loaded with medications and scheduling information via unit 12. Container 14 can then be removed from unit 12 and carried or moved around to the location of various individuals who are scheduled to receive one or more of the medications stored therein in accordance with a predetermined schedule.

When an individual has been appropriately identified, one or more compartments within container 14 can automatically open to provide access to the medications previously loaded therein. The medications can be provided to the individual. The process of accessing the medications can also be logged within container 14 for purposes of providing an audit trail which could be downloaded to unit 12 and examined by the operator or user via terminal 30. Hard copy printouts can also be provided as desired.

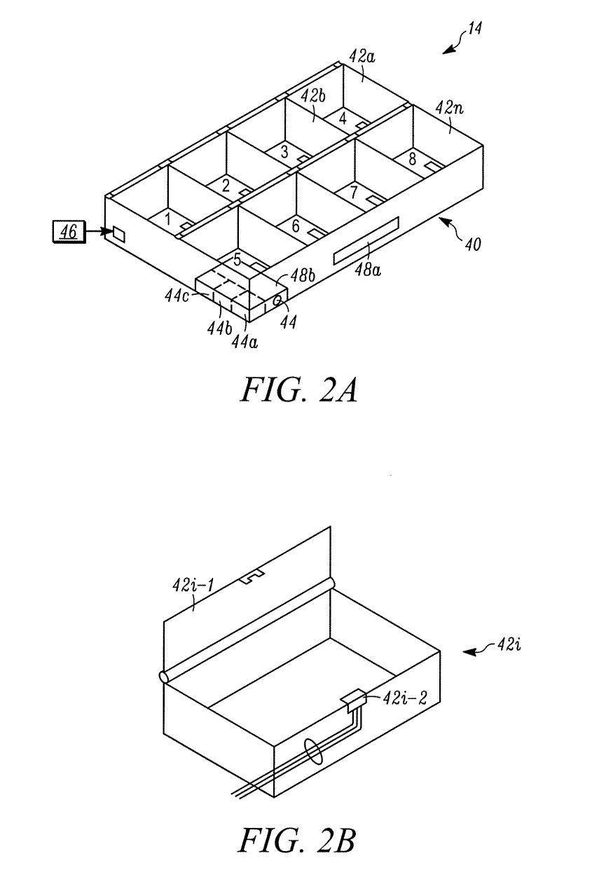

FIGS. 2A and 2B together illustrate various details of the dispensing container 14. Container 14 includes a housing indicated generally at 40 which defines a plurality of internal compartments such as 42a, 42b . . . 42n. In an exemplary embodiment, a total of 8 compartments have been provided.

Each of the compartments 42a, 42b . . . 42n can be loaded with one or more medications by the unit 12 and securely closed with a lid or cover best seen in FIG. 2B, 42i-1. The lid or cover 42i-1 can be locked closed by an electrically actuatable latch 42i-2.

Housing 40 can also carry a control unit 44 and battery. Control unit 44 can incorporate a programmable processor 44a and associated software 44b which can executed by the processor 44a to dispense medication in accordance with a preloaded schedule therein. Such a schedule might be stored in a storage unit 44c.

Housing 40 also carries a connector for a bar code reader or other type of scanner such as an RFID scanner 46. The scanner 46 can scan an individual's identification badger or bracelet to inform the control unit 44 as to the identity of the individual who is to receive one more medications stored in the compartments 42a, 42b . . . 42n. Depending on the dispensing schedule stored in unit 44c, and the signals received via scanner 46 the control unit 44 can actuate respective ones of the latches such as 42i-2 to release the respective cover or lid 42i-1.

The dispensing container 14 can communicate with the person carrying out the dispensing via an alphanumeric display such as 48a or audibly via an audible output device indicated generally at 48b. If desired, a hard copy can be generated for audit purposes.

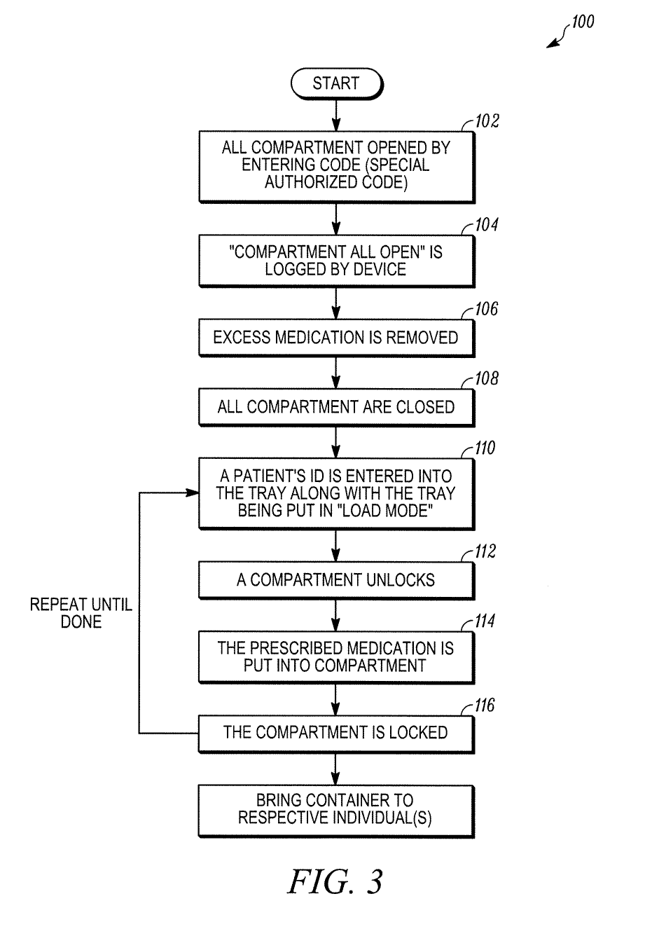

FIG. 3 illustrates aspects of a method in accordance with the invention. Initially, relative to the dispensing unit 12 which has received the container 14, all compartments of container 14 can be opened, as 102. A “compartment all open” indication can be logged by the device 12 as at 104. In the event that some of the compartments of unit 14 still contain medication, such medication can be removed as at 106. All compartments are then closed and locked as at 108.

For purposes of loading the container 14, the patient's identifier can be entered, via terminal 30, and the dispensing unit 12 along with the container 14 can be put into a “load mode” as at 110. In a preferred embodiment, only one compartment on the container 14 can be opened at a time.

A compartment associated with the individual's id can then be unlocked as at 112. The prescribed medication can then be loaded into the respective compartment as at 114. The compartment can then be locked at 116.

The above process can then be repeated until all of the desired compartments have been loaded with the appropriate medications for the respective individual. Loaded compartments can only be opened in the vicinity of the individual, or, in response to the “compartment all open” command as at 104. The container 14 can then be moved to the vicinity of one or more individuals who are to receive the stored medication or medications.

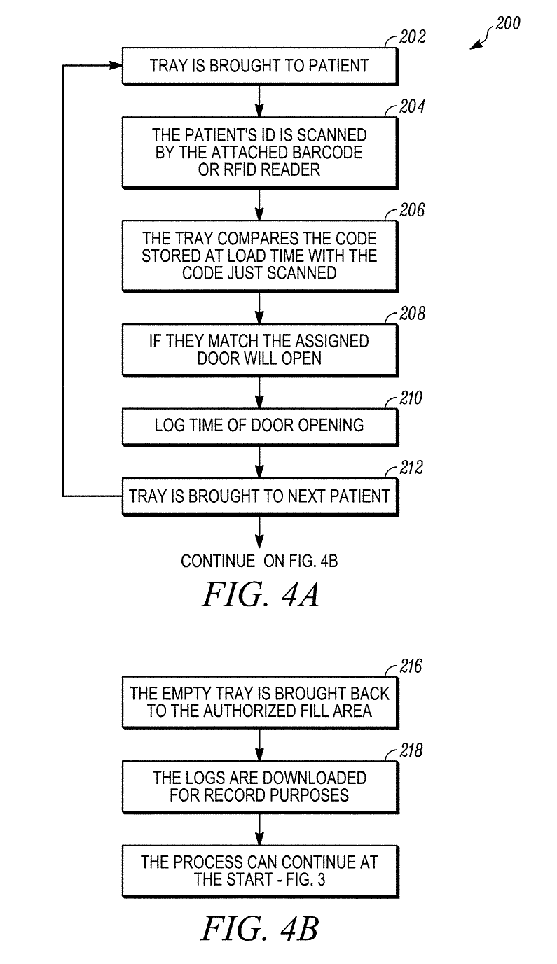

It will be understood that the processing 100 of FIG. 3 could be carried out in part by a licensed professional such as a physician or registered nurse. FIGS. 4A and 4B taken together illustrate aspects of processing and method 200 wherein the medications loaded into the container 14 by the processing of the method 100 can be dispensed to the respective individual or individuals. Depending on the jurisdiction, it might be possible for the dispensing method 200 to be carried out by an individual less training than the individual who has loaded the container 14.

The container 14 is brought to the individual or patient who requires medication as at 202. Scanner 46 can be used to identify the patient by scanning a bar code or RFID-type tag on or associated with the individual, a wrist band for example, using scanner 46 as at 204.

The control circuitry 44 of the container 14 compares the scanned code with individual identification and/or dispensing schedule information of storage unit 44c as at 206. In the presence of a match, as at 208, the respective latch, such as the latch 42i-2 is energized to release the associated cover or lid 42i-1 of the respective compartment which makes is possible to administer respective medication contained therein to that individual. The time that the cover 42i-1 opened can then be logged, as at 210 by the control unit 44.

The container 14 can then be brought to the next individual or patient as at 212. The process is repeated until the medications preloaded into container 14 have been dispensed to the appropriate individuals, assuming that they are available.

Once the available individuals have received their medication, as illustrated on FIG. 4B the container 14 can then be returned to the area of the dispensing mechanism 12 as at 216. The log automatically maintained within the container 14 can then be downloaded to the dispensing unit 12 as at 218.

The process 100 can then be repeated, see FIG. 3, as needed.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus comprising:
an automated medication dispenser which includes a medication dispensing data base;
a portable medication storage and dispensing container, separate from the automated dispenser, and automatically loadable with a plurality of medications by the dispenser, the medications to be distributed to various individuals;
where the dispensing container includes a housing, the housing defines a plurality of separately closable compartments;
where the dispenser receives the housing and accesses compartments thereof to automatically load same with selected medications; and
where the dispensing container includes control circuits and associated storage for dispensing schedules.

2-10. (canceled)

11. An apparatus as in claim 1 where at least some of the compartments can be closed with separately movable covers.

12. An apparatus as in claim 11 where the control circuits are coupled to at least the compartments with separately closable covers.

13. An apparatus as in claim 12 where the control circuits release the closable covers for medication dispensing in accordance with the dispensing schedule.

14. An apparatus as in claim 12 where the control circuits release the closable covers when the dispensing container has been received by the dispenser.

15. An apparatus as in claim 12 where the housing carries a scanner coupled to the control circuits.

16. An apparatus as in claim 15 where the control circuits include a programmable processor and executable software which receive an identifier of an individual from the scanner, and including software to compare the identifier to identifiers associated with medications contained in the dispensing container.

17. An apparatus as in claim 15 where the control circuits, responsive to a comparison of an identifier to identifiers associated with medications contained in the dispensing container, release selected closable covers to make accessible medications for the individual.

18. A dispensing container comprising:
a portable housing;
a scanner carried by the housing;
a plurality of separate compartments defined in the housing with the compartments each separately closable by a movable cover; and
control circuits coupled to the scanner and the covers.

19. A container as in claim 18 which includes a storage element, coupled to the control circuits, and associated executable software, to load a multi-person product dispensing schedule into the storage element.

20-34. (canceled)
